(19) United States
(12) Patent Application Publication
(10) Pub. No.: US 2012/0265759 A1
(43) Pub. Date: Oct. 18, 2012

(54) FILE PROCESSING OF NATIVE FILE FORMATS

(75) Inventors: John E. BERGERON, Fairport, NY (US); John Allott Moore, Rochester, NY (US)

(73) Assignee: XEROX CORPORATION, Norwalk, CT (US)

(21) Appl. No.: 13/087,819

(22) Filed: Apr. 15, 2011

(51) Int. Cl. G06F 17/30; G06F 7/00

(52) U.S. Cl. 707/740; 707/812; 707/756; 707/E17.058; 707/E17.089

(57) ABSTRACT

A computer-implemented method for processing electronic documents having different native file formats is provided. The method is implemented in a computer system comprising one or more processors configured to execute one or more computer program modules. The method includes (a) receiving electronic documents in different native file formats; (b) identifying the native file format for each received electronic document; (c) retrieving a stored configuration data for the identified native file format, the configuration data includes a mapping of regions of interest in the electronic document with the identified native file format and their associations with output fields; and (d) processing the electronic documents using their retrieved configuration data to extract data from the electronic documents.

### BACKGROUND

1. Field

The present disclosure relates to a method and a system for storing configuration data for electronic documents having different native file formats and processing such electronic documents.

2. Description of Related Art

Electronic documents are ubiquitous in work and home environments. Word processing files, graphical images, spreadsheets, electronic mail messages and the like are commonly used to record, display and transfer information.

Virtually all document imaging based services start with a scanned input. How these input documents get scanned or created may vary from solution-to-solution. The original documents often start out as native file formats, like Microsoft® Word files or Adobe® PDF files. In some cases, the user prints the original document and then faxes or sends the hardcopy (of the original document) to some centralized facility, which in turn scans the hardcopy to make an electronic version (of the original document) for easier tracking and data extraction. In other cases, the user sends the original document via electronic mail (e.g., as an attachment), and the receiving system rasterizes it into an image file.

The resulting image files are then processed using technologies like OCR (Optical Character Recognition), OMR (Optical Mark Recognition), and ICR (Intelligent character recognition) to automatically extract the content in the original documents. Some drawbacks with these types of systems is that they are often very compute-intensive and storage intensive. Also, these types of systems generally require the document to be transformed into a representative image.

Some examples of conventional data extraction techniques may include ETL (Extract, Transform, and Load) technique that is used in data warehousing and e-Discovery technique that is used in litigation services. ETL is more focused on one-to-one mapping or data relationships. E-Discovery is configured to manage more adhoc/unstructured data and is concerned with creating a full text index and then searching based on a set of key terms.

The present disclosure provides improvements in storing and processing electronic documents having different native file formats.

### SUMMARY

According to one aspect of the present disclosure, a computer-implemented method for storing configuration data for electronic documents having different native file formats is provided. The method is implemented in a computer system comprising one or more processors configured to execute one or more computer program modules. The method includes (a) receiving and displaying an electronic document in its native file format; (b) receiving a user input for identifying regions of interest in the displayed electronic document for data extraction; (c) receiving a user input for associating each region of interest with a corresponding defined output field; (d) storing configuration data for the electronic document, the configuration data comprising the regions of interest and their associations with corresponding defined output fields; and (e) performing procedures (a) through (d) for other electronic documents to obtain and store configuration data for those electronic documents.

According to another aspect of the present disclosure, a computer-implemented method for processing electronic documents having different native file formats is provided. The method is implemented in a computer system comprising one or more processors configured to execute one or more computer program modules. The method includes (a) receiving electronic documents in different native file formats; (b) identifying the native file format for each received electronic document; (c) retrieving a stored configuration data for the identified native file format, the configuration data includes a mapping of regions of interest in the electronic document with the identified native file format and their associations with output fields; and (d) processing the electronic documents using their retrieved configuration data to extract data from the electronic documents.

According to yet another aspect of the present disclosure, a system for processing electronic documents having different native file formats is provided. The system includes a processor configured to: (a) receive electronic documents in different native file formats; (b) identify the native file format for each received electronic document; (c) retrieve a stored configuration data for the identified native file format, the configuration data includes a mapping of regions of interest in the electronic document with the identified native file format and their associations with output fields; and (d) process the electronic documents using their retrieved configuration data to extract data from the electronic documents.

According to yet another aspect of the present disclosure, a processor readable medium comprising program code executable by a processor to carry out a method for storing configuration data for electronic documents having different native file formats is provided. The method includes (a) receiving and displaying an electronic document in its native file format; (b) receiving a user input for identifying regions of interest in the displayed electronic document for data extraction; (c) receiving a user input for associating each region of interest with a corresponding defined output field; (d) storing configuration data for the electronic document, the configuration data comprising the regions of interest and their associations with corresponding defined output fields; and (e) performing procedures (a) through (d) for other electronic documents to obtain and store configuration data for those electronic documents.

According to another aspect of the present disclosure, a processor readable medium comprising program code executable by a processor to carry out a method for processing electronic documents having different native file formats is provided. The method includes (a) receiving electronic documents in different native file formats; (b) identifying the native file format for each received electronic document; (c) retrieving a stored configuration data for the identified native file format, the configuration data includes a mapping of regions of interest in the electronic document with the identified native file format and their associations with output fields; and (d) processing the electronic documents using their retrieved configuration data to extract data from the electronic documents.

Other objects, features, and advantages of one or more embodiments of the present disclosure will seem apparent from the following detailed description, and accompanying drawings, and the appended claims.

### BRIEF DESCRIPTION OF THE DRAWINGS

Various embodiments will now be disclosed, by way of example only, with reference to the accompanying schematic drawings in which corresponding reference symbols indicate corresponding parts, in which

FIGS. 1 and 2 illustrate schematic views of a computer-implemented method for storing configuration data for electronic documents having different native file formats in accordance with an embodiment of the present disclosure;

FIGS. 3 and 4 illustrate schematic views of a computer-implemented method for processing electronic documents having different native file formats in accordance with an embodiment of the present disclosure; and

FIG. 5 illustrates a system for storing configuration data for electronic documents having different native file formats and for processing the electronic documents in accordance with an embodiment of the present disclosure.

### DETAILED DESCRIPTION

The present disclosure provides a system and a set of methods wherein data or information is extracted from a collection of documents provided in a number of different electronic formats. The system of the present disclosure directly consumes virtually any native file format documents, extracts information and data from the documents, formats and stores the extracted information or data for subsequent processing.

The method of the present disclosure includes a configuration sub-method and a runtime sub-method. The configuration sub-method allows a user a) to visually identify elements and/or regions on a received document (in virtually any native file format) using an advanced or a specialized viewer and b) to associate the identified elements and/or regions with fields to be output by the system. The configuration sub-method also includes storing, for each electronic document, the regions of interest and their associations with corresponding defined output fields. The runtime processing sub-method includes a) identifying the native file format of the document upon input and b) processing the associated document according to configuration settings that are saved during the configuration sub-method to extract the desired data.

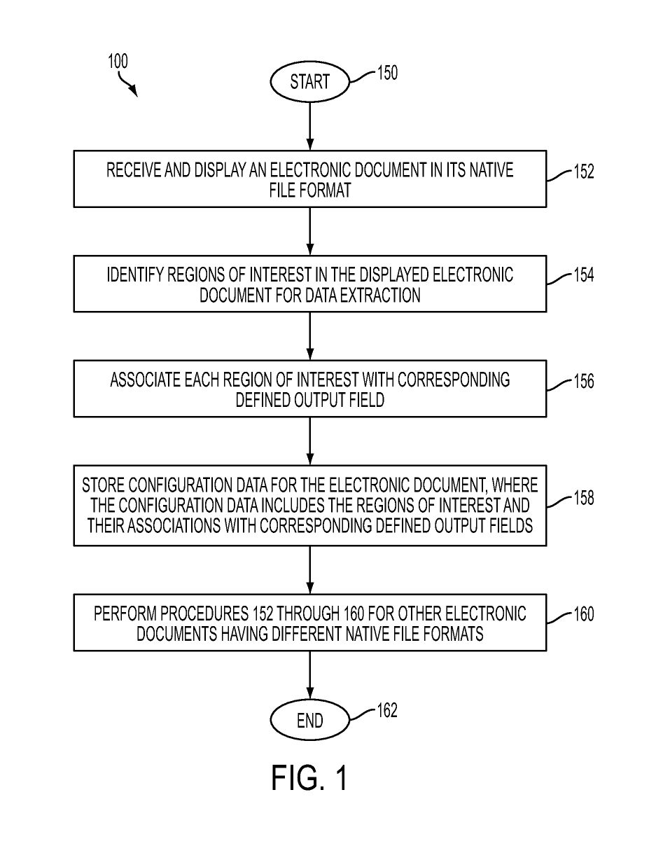

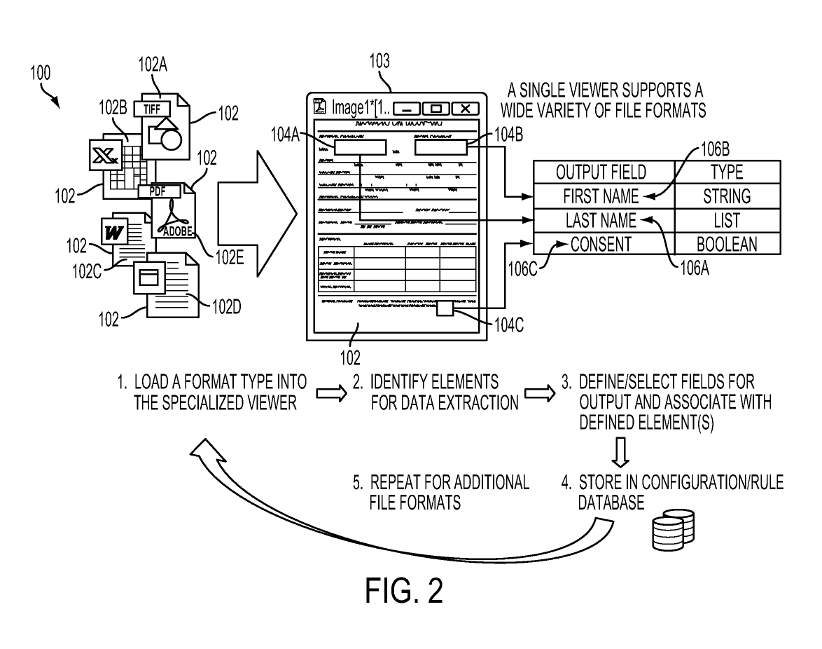

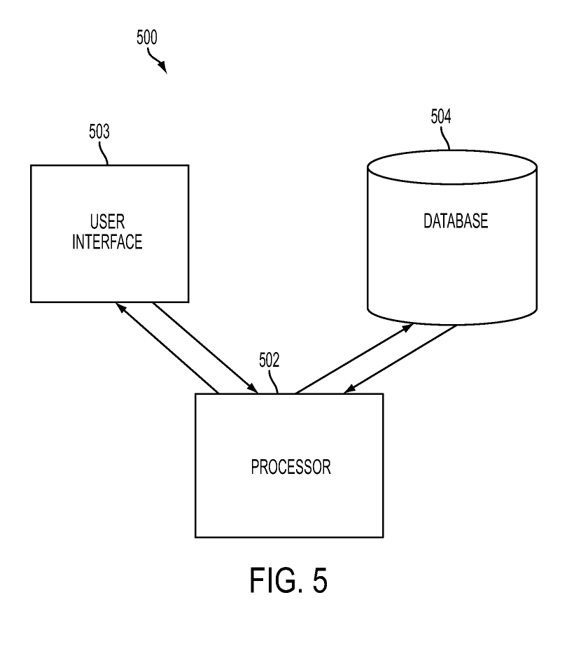

FIGS. 1 and 2 illustrate schematic views of a computer-implemented method 100 for storing configuration data for electronic documents 102 (e.g., electronic documents 102A-102E are shown in FIG. 2) having different native file formats in accordance with an embodiment of the present disclosure. The method 100 is implemented in a computer system comprising one or more processors 502 (as shown in and explained with respect to FIG. 5) configured to execute one or more computer program modules. In order for a workflow queue to be able to process the electronic documents 102 with different native file file formats, a system 500 (as shown in FIG. 5) is first configured to work with each of these native file file formats. FIGS. 1 and 2 illustrate the procedures used to configure a given workflow.

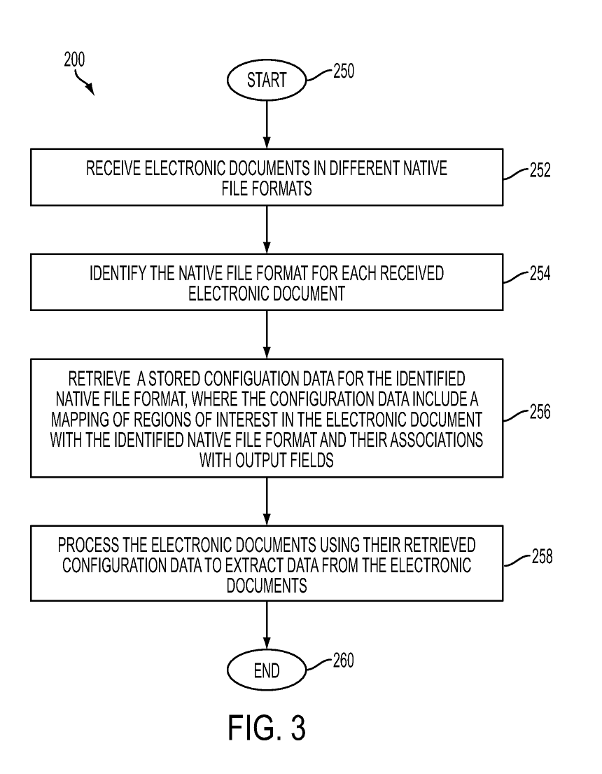

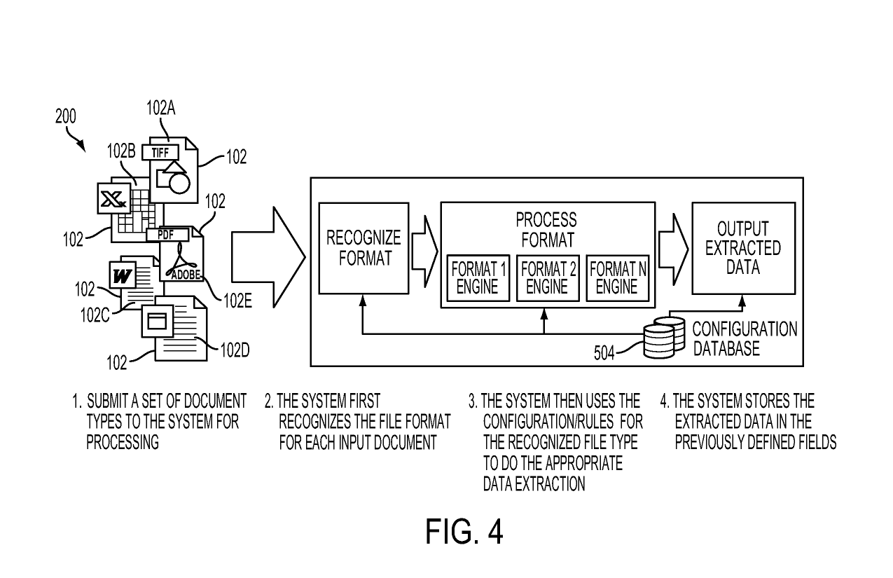

Referring to FIGS. 1 and 2, the method 100 begins at procedure 150. At procedure 152, an electronic document 102 is received in its native file format. The electronic document 102 may be a sample file that is representative of an actual document to be processed during runtime processing (i.e., shown in and explained with respect to FIGS. 3 and 4).

The electronic document 102 may include, for example, a graphical image file 102A, a spreadsheet file 102B, a word processing file 102C, a presentation program file 102D, a Portable Document Format (PDF) file 102E, a text file and/or an electronic mail message file.

The native file format of the electronic document generally refers to a (logical) structure used to store information in a computer file. In other words, the native file format is a default file format which an application or a program uses for creating a computer file. Some example native file formats may include PDF, PostScript, text, HTML, XTML, image files, such as TIFF, BMP, JPG, GIF, etc., Microsoft® Office files, such as Microsoft® Word, Microsoft® PowerPoint, Microsoft® Excel, etc. These examples are not indented to be limiting in any way, and therefore should not be construed in that manner. It is contemplated that the present disclosure can use any other native file formats that can be appreciated by one skilled in the art.

The received electronic document 102 is then displayed in an advanced or specialized file viewer 103, shown in FIG. 2, to the user for identifying regions or objects in the received electronic document 102.

The file viewer 103 may be a program or an application that is capable of reading (or viewing) and displaying data in different native file formats. The file viewer 103 may include a number of modules for supporting these different native file formats. The file viewer 103 may include a (single) user interface through which different native file formats can be viewed. The file viewer 103 is configured to display different native file formats, for example, image files, such as TIFF, BMP, JPG, GIF, etc., Microsoft Office files, such as Microsoft Word, Microsoft PowerPoint, Microsoft Excel, etc and/or any other native file formats, such as Portable Document Format (PDF), text file, electronic mail message file, etc. These examples are not intended to be limiting in any way, and therefore should not be construed in that manner. It is contemplated that the file viewer 103 may be configured to display any other native file formats that can be appreciated by one skilled in the art.

Next at procedure 154, regions of interest 104A-104C in the displayed electronic document 102 are identified by the user for data extraction.

In one embodiment, the user may place bounding structure(s) that surrounds region or regions of interest. The bounding structures may have any shape, for example, rectangular shape, circular shape, elliptical shape, square shape etc. In another embodiment, the user may simply highlight the desired region or regions of interest.

The user may specify one or more anchors within the electronic document. The anchor may be a fixed point within the electronic document that is used to aid in marking regions of interest in image files (e.g., TIFF, JPEG, etc.). The anchor may be small sub-image areas within the electronic document. The user may then define regions of interest relative to these anchors on the electronic document. The anchors, thus, serve to mark regions of interest within the electronic document from which data will be extracted. That is, these surrounding anchors may be used to allow for relative region of interest definition in the electronic document.

The surrounding anchors may allow for some minor document registration shifting or element flow based on variable content. Even if the electronic document is distorted (e.g., scaled, skewed, or cropped etc.), the region of interest can still be found if the anchor(s) can be identified. Usage of anchors in data extraction is discussed in “Learning Image Anchor Templates for Document Classification and Data Extraction,” by Sarkar, P. in Pattern Recognition (ICPR), 2010 20th International Conference 23-26 Aug., 2010, which herein is incorporated by reference in its entirety. It is contemplated that the user may use any other procedures, as would be appreciated by one skilled in the art, to identify the regions of interest in the displayed electronic document.

At procedure 156, an output field 106 for each region of interest 104 is defined. Each region of interest 104 is then associated with corresponding defined output field 106. For example, output fields 106A-C are defined for identified regions of interest 104A-104C. The output field may include a new data element that is created in a database 504 to store the extracted data from the corresponding region of interest.

For example, if user identifies first name of the applicant, last name of the applicant and applicant's consent as the data that he/she wishes to extract from an application for employment document, then output fields corresponding to these identified fields of interest are created in a database 504. The properties (e.g., type, length, etc.) for these created output fields are also defined in the database 504. For example, the type of the output field corresponding to the applicant's consent may be defined as boolean and the type of the output field corresponding to the first or last name may be defined as string.

At procedure 158, configuration data for the electronic document 102 is stored in the database 504. The configuration data includes the regions of interest 104 and their associations with corresponding defined output fields 106. As will be explained in discussions below, the stored configuration data for each electronic document 102 is retrieved for use during the runtime processing of the related and/or similar electronic document 102.

Rules (e.g., regular expression, string length, etc) or hints may be defined along with the configuration data to help in data extraction. One or more rules or hints may be established for populating the output field. A rule may include a variety of processing steps or attributes, which are used to assemble, collect, and organize the data that populates the output field. That is, these rules may help ensure that the extracted data is valid (i.e., types or amounts) before the data is stored in the database and/or formatted for further processing. For example, a date validation rule may include that the data extracted for the date output field “must be exactly eight numeric digits” and “must be within a given date range.” These rules may be defined at procedures 154 and 156 when the regions of interest are identified and the output fields are defined. As will clear from the discussions below, during the processing of these electronic documents, these rules may be applied to the extracted data to ensure valid information is provided in the received documents. That is, as discussed below, using these rules, the system is configured to check the validity of the data being extracted (e.g., format of the date provided in the received documents) from the documents and to notify the sender (of the documents having invalid date) of the detected errors.

Assumptions may be made for defining the configuration data of one file format. These assumptions may then be used later to semi-automate the procedure of defining the configuration data of subsequent similar and/or related file formats. That is, once a file format has been configured, the configuration data from the configured file format may then be used as assumptions for subsequent file formats to be configured. For example, the Region of Interest for a given field in a Microsoft Word file format may be used as an assumption for defining configuration data of a PDF file format.

At procedure 160, the procedures 152 through 158 are performed for other electronic documents to obtain and store the configuration data for those electronic documents. These other electronic documents may include electronic documents having different native file formats and having same content. For example, the system may be used for configuring and/or processing, for example, “W4” forms in several native file formats. In one embodiment, it may be assumed that the system of the present disclosure is defined/used based on a priori knowledge of the “document type” being processed.

In another embodiment, the system of the present disclosure may be used for configuring and/or processing other electronic documents, such as, for example, electronic documents having different native file formats and having different content, electronic documents having same native file format and having different content, etc.

In one embodiment, as shown in FIG. 2, the plurality of electronic documents 102A-102E may be received by the system 500 at the procedure 150. In such embodiment, a received electronic document 102A is first loaded into the file viewer 103 for identifying regions or objects in the received electronic document 102A, and configuration data for the received electronic document 102A is obtained and stored in a database 504. After storing the configuration data of the first received electronic document 102A, the next received electronic document 102B is loaded into the file viewer 103 for identifying regions or objects in the received electronic document 102B and obtaining and storing the configuration data of the received electronic document 102B. The procedures 152-160 are repeated for other received electronic documents 102C-102E to store their respective configuration data.

The method 100 of the present disclosure may optionally include a procedure in which document classification techniques may be used to further classify the electronic documents based on its content. For example, multiple invoices may be received in PDF file format. However, these PDF invoices may look different and have different content based on the source (e.g., vendor) from which they are obtained/received. Therefore, these PDF invoices may be further sub-classified into categories based on, for example, content to be extracted.

This optional document classification procedure may be performed during the configuration method 100 (i.e., during storing of the configuration data of the received electronic documents). The classification information of the electronic document may then be stored along with the configuration data. As will be clear from the discussions below, this document classification information of the electronic document may be used during the processing of the electronic document.

In addition to the regions of interest and their associations with corresponding defined output fields, the configuration data may also include assumptions, rules or hints, document classification information or any other data relevant to the electronic document that may be used during the processing of the electronic document.

The method 100 may include additional procedure(s) for validating and refining the configuration data for an electronic document based on extensive testing with mutiple sample files for the electronic document. The method 100 ends at procedure 162.

FIGS. 3 and 4 illustrate schematic views of a computer-implemented method 200 for processing the electronic documents 102 (e.g., electronic documents 102A-102E as shown in FIG. 2) having different native file formats in accordance with an embodiment of the present disclosure. The method 200 is implemented in a computer system comprising one or more processors 502 (as shown in and explained with respect to FIG. 5) configured to execute one or more computer program modules.

The method 200 begins at procedure 250. At procedure 252, electronic documents 102 are received in different native file formats.

At procedure 254, the native file format for each received electronic document 102 is identified. The file format may be identified using file name extension (i.e., based on the section of the file name following the final period). The file format may be identified using internal metadata, for example, file header or magic number. Such internal metadata is stored inside the received electronic document itself and contains information regarding the file format. Other file format identification techniques that are appreciated by one skilled in the art may be used in the present disclosure to identify the native file format of the received electronic document 102.

After the native file format for the received electronic documents 102 are identified, at procedure 256, a stored configuration data for the identified native file format is retrieved from the database 504. This configuration data for the received electronic document 102 is stored during the configuration method 100 (as explained in procedures 152-160 shown in FIGS. 1 and 2) before the runtime processing. The configuration data includes a mapping of regions of interest in the electronic document 102 with the identified native file format and their associations with output fields.

The method 200 of the present disclosure may optionally include a procedure in which document classification type may be identified. For example, the optional procedure for document classification type may be performed after identifying the native file format and before processing the received electronic document.

As noted above, the document classification type information of the electronic document may be stored in the configuration data. Identifying the document classification type of the electronic document being processed may aid or help in processing the electronic document effectively and efficiently to extract the desired data from the electronic document. For example, during configuration, multiple invoices (having different content) received/obtained in PDF file format are sub-classified into categories based on the content. During processing, the system 200 first identifies that the electronic document is in a PDF native file format and then identifies the category of the electronic document, thus, utilizing the identified category to extract the desired information from the PDF invoice that is being processed.

At procedure 258, the electronic documents 102 are processed using their retrieved configuration data to extract data from the electronic documents. That is, the electronic documents 102 are routed to appropriate data extaction engines for the identified file type. The processing of these electronic documents 102 may include extracting data from the electronic documents 102 and storing the desired data from the document 102 into the database 504.

During processing of the electronic documents, rules (e.g., regular expression, string length, etc) or hints, which are defined during the configuration procedure, may be applied to the extracted data to ensure valid information is provided in the received documents. For example, date rules (i.e., regular expression) may be used to check the validity of format of the date provided in the received documents. As another example, field length (string length) rules may be used to check the validity of account numbers provided in the received documents. By applying these rules or hints, the system of the present disclosure is configured to detect error(s) in the extracted data. The system may further be configured to notify the sender (of the documents having invalid data) of the detected errors. The sender may then resubmit the documents with corrected data.

The extracted data may be formatted before storing the extracted data in the output fields in the database 504. The extracted data is saved or stored in the output fields in the database 504. The stored data may then be used for further processing. This may include displaying the stored data to the user in a pre-defined format.

In one embodiment, the method 200 is configured to process different received electronic documents 102 one after another. In another embodiment, the method 200 is configured to process multiple different received electronic documents 102 simultaneously, where each received electronic document (in a specific file format) is independently processed by a format engine or processor. The method 200 ends at procedure 260.

FIG. 5 illustrates the system 500 for processing electronic documents 102 having different native file formats in accordance with an embodiment of the present disclosure. The system 500 includes the processor 502, the database 504 and the user interface 503.

The processor 502 may comprise either one or a plurality of processors therein. The processor 502 is configured to: (a) receive electronic documents in different native file formats; (b) identify the native file format for each received electronic document; (c) retrieve a stored configuration data for the identified native file format, the configuration data comprising a mapping of regions of interest in the electronic document with the identified native file format and their associations with output fields; and (d) process the electronic documents using their retrieved configuration data to extract data from the electronic documents.

The database 504 is configured to store the configuration data for the electronic documents 102 in different native file formats. The database 504 may be in communication with the processor 502.

The database 504 may also be configured to store the data extracted from the electronic documents. In one embodiment, the database 504 or memory is a standalone device. However, it is contemplated that the database 504 or memory may be part of the processor 502.

The user interface 503 may include a graphical user interface (GUI) and a user input device. The user interface 503 may be in communication with the processor 502. The user interface 503, the database 504 and the processor 502 may be coupled together via data communication links. These links may be any type of link that permits the transmission of data, such as direct serial connections, a local area network (LAN), wide area network (WAN), an intranet, the Internet, circuit wirings, and the like.

As noted above, the file viewer 103 may be a program or an application that is capable of reading (or viewing) and displaying data in different native file formats on the graphical user interface. The file viewer 103 may include a (single) user interface through which different native file formats can be viewed.

The user input device may include a keyboard, mouse, keypad or touch screen that allows the user to identify regions of interest in the electronic document displayed on the user interface. The user input device also allows the user to define an output field for each identified region of interest, and to associate each identified region of interest with corresponding defined output field.

In one embodiment, the user interface 503 may be provided integral with the processor 502. In another embodiment, the user interface 503 may be provided remote from or proximal to the processor 502.

The system 500 is also configured to process multiple different workflow queues simultaneously, where each workflow queue is configured independently process electronic documents 102 in a specific file format.

Thus, the present disclosure provides the methods 100 and 200 and the system 500 that are capable of accepting electronic documents into an input queue in many different native file formats, processing each of these electronic documents to extract the desired data and storing the desired data for further processing.

Even though the configuration method 100 and the run time processing method 200 are shown and described separately, it is contemplated that the methods 100 and 200 may be combined together such that the method 200 is performed after the method 100.

The methods and the system of the present disclosure provides cost savings by (a) reducing computational time required to perform the data extraction, (b) reducing data entry labor required to perform the data extraction, and/or (c) reducing OCR correction in comparison to traditional image-based approaches. The methods and the system of the present disclosure further saves time by reducing unnecessary printing, scanning, and converting documents.

The system of the present disclosure processes multiple native file formats to extract data from both structured and semi-structured documents. For example, data extracted may be business process oriented data in structured and semi-structured documents. The structured documents generally have the same structure and appearance. In these structured documents, every data field is located at the same place for all documents. Examples of some structured documents may include questionnaires, tests, insurance forms, tax returns, ballots, etc. The semi-structured documents generally have the same structure but their appearance depends on number of items and other parameters. Examples of some semi-structured documents may include invoices, purchase orders, waybills, etc.

The methods and the system of the present disclosure may format the extracted data in an electronic data interchange (EDI) schema and store the formatted data for subsequent processing. Electronic data interchange (EDI) generally refers to structured transmission (via electronic means) of business data or information based on approved formatting standards and schemas between various business entities. This business data or information may be related to a specific industry, for example, health care, finance, etc. The methods and the system of the present disclosure may also format the extracted data in a user defined data schema and store the formatted data for subsequent processing.

In the embodiments of the present disclosure, the processor, for example, may be made in hardware, firmware, software, or various combinations thereof. The present disclosure may also be implemented as instructions stored on a machine-readable medium, which may be read and executed using one or more processors. In one embodiment, the machine-readable medium may include various mechanisms for storing and/or transmitting information in a form that may be read by a machine (e.g., a computing device). For example, a machine-readable storage medium may include read only memory, random access memory, magnetic disk storage media, optical storage media, flash memory devices, and other media for storing information, and a machine-readable transmission media may include forms of propagated signals, including carrier waves, infrared signals, digital signals, and other media for transmitting information. While firmware, software, routines, or instructions may be described in the above disclosure in terms of specific exemplary aspects and embodiments performing certain actions, it will be apparent that such descriptions are merely for the sake of convenience and that such actions in fact result from computing devices, processing devices, processors, controllers, or other devices or machines executing the firmware, software, routines, or instructions.

While the present disclosure has been described in connection with what is presently considered to be the most practical and preferred embodiment, it is to be understood that it is capable of further modifications and is not to be limited to the disclosed embodiment, and this application is intended to cover any variations, uses, equivalent arrangements or adaptations of the present disclosure following, in general, the principles of the present disclosure and including such departures from the present disclosure as come within known or customary practice in the art to which the present disclosure pertains, and as may be applied to the essential features hereinbefore set forth and followed in the spirit and scope of the appended claims.

What is claimed is:

1. A computer-implemented method for storing configuration data for electronic documents having different native file formats, wherein the method is implemented in a computer system comprising one or more processors configured to execute one or more computer program modules, the method comprising the following procedures:
(a) receiving and displaying an electronic document in its native file format;
(b) receiving a user input for identifying regions of interest in the displayed electronic document for data extraction;
(c) receiving a user input for associating each region of interest with a corresponding defined output field;
(d) storing configuration data for the electronic document, the configuration data comprising the regions of interest and their associations with corresponding defined output fields; and
(e) performing the procedures (a) through (d) for other electronic documents to obtain and store configuration data for those electronic documents.

2. The method of claim 1, further comprising receiving a user input for classifying the electronic documents into one or more categories based on its content.

3. The method of claim 2, further comprising storing classification information of the electronic document along with the configuration data.

4. The method of claim 3, further comprising processing the electronic documents having different native file formats, wherein the processing includes the following procedures:
(1) receiving the electronic documents in different native file formats;
(2) identifying the native file format for each received electronic document;
(3) retrieving the stored configuration data for the identified native file format; and
(4) processing the electronic documents using their retrieved configuration data to extract data from the electronic documents.

5. The method of claim 4, further comprising formatting the extracted data and storing the formatted data in the output fields for further processing.

6. A computer-implemented method for processing electronic documents having different native file formats, wherein the method is implemented in a computer system comprising one or more processors configured to execute one or more computer program modules, the method comprising the following procedures:
(a) receiving electronic documents in different native file formats;
(b) identifying the native file format for each received electronic document;
(c) retrieving a stored configuration data for the identified native file format, the configuration data comprising a mapping of regions of interest in the electronic document with the identified native file format and their associations with output fields; and
(d) processing the electronic documents using their retrieved configuration data to extract data from the electronic documents.

7. The method of claim 6, further comprising formatting the extracted data and storing the data in the output fields for further processing.

8. The method of claim 6, further comprising storing the configuration data for the electronic documents, wherein the storing is performed before the procedure (a).

9. The method of claim 8, wherein the storing the configuration data for the electronic documents includes the following procedures:
(1) receiving and displaying the electronic document in its native file format;
(2) receiving a user input for identifying regions of interest in the displayed electronic document for data extraction;
(3) receiving a user input for associating each region of interest with a corresponding defined output field;
(4) storing configuration data for the electronic document, the configuration data comprising the regions of interest and their associations with corresponding defined output fields; and
(5) performing the procedures (1) through (4) for other electronic documents to obtain and store configuration data for those electronic documents.

10. A system for processing electronic documents having different native file formats, the system comprising:
a processor configured to:
(a) receive electronic documents in different native file formats;
(b) identify the native file format for each received electronic document;
(c) retrieve a stored configuration data for the identified native file format, the configuration data comprising a mapping of regions of interest in the electronic document with the identified native file format and their associations with output fields; and
(d) process the electronic documents using their retrieved configuration data to extract data from the electronic documents.

11. The system of claim 10, wherein the electronic documents having different native file formats are processed simultaneously.

12. The system of claim 10, further comprising a user interface configured to display the electronic document in its native file format.

13. The system of claim 12, further comprising a database configured to store the configuration data for the electronic documents.

14. A processor readable medium comprising program code executable by a processor to carry out a method for storing configuration data for electronic documents having different native file formats, the method comprising the following procedures:
(a) receiving and displaying an electronic document in its native file format;
(b) receiving a user input for identifying regions of interest in the displayed electronic document for data extraction;
(c) receiving a user input for associating each region of interest with a corresponding defined output field;
(d) storing configuration data for the electronic document, the configuration data comprising the regions of interest and their associations with corresponding defined output fields; and
(e) performing the procedures (a) through (d) for other electronic documents to obtain and store configuration data for those electronic documents.

15. A processor readable medium comprising program code executable by a processor to carry out a method for processing electronic documents having different native file formats, the method comprising the following procedures:
(a) receiving electronic documents in different native file formats;
(b) identifying the native file format for each received electronic document;
(c) retrieving a stored configuration data for the identified native file format, the configuration data comprising a mapping of regions of interest in the electronic document with the identified native file format and their associations with output fields; and
(d) processing the electronic documents using their retrieved configuration data to extract data from the electronic documents.
